(19) United States
(12) Patent Application Publication
(10) Pub. No.: US 2019/0019337 A1
(43) Pub. Date: Jan. 17, 2019

(54) AUGMENTED REALITY SOCIAL MEDIA PLATFORM

(71) Applicant: Monsarrat, Inc., Cambridge, MA (US)

(72) Inventor: Jonathan Monsarrat, Cambridge, MA (US)

(21) Appl. No.: 15/975,659

(22) Filed: May 9, 2018

Related U.S. Application Data
(60) Provisional application No. 62/504,833, filed on May 11, 2017.

(51) Int. Cl. G06T 19/00; G06Q 30/02; A63F 13/65; G06Q 50/00; G06F 9/54

(52) U.S. Cl. CPC G06T 19/006; G06Q 30/0209; G06F 9/54; G06Q 50/01; A63F 13/65

(57) ABSTRACT

A social media platform where users can contribute content specialized for display through an augmented reality system on a mobile device with a camera. This content includes flat images, video, and text, which is shown in 2D, 3D models, and extended quests made of up a series of 3D models. Moderators set up “dimensions”, feeds of content on a similar topic. These feeds are shown to users along a path that they follow in the real world, like billboards alongside a highway. Users chose or follow the dimensions they want to see content from. They see the content and able to share, rate, respond to, and interact with it.

### CROSS REFERENCE TO RELATED APPLICATIONS

This application claims priority to U.S. Provisional Application Ser. No. 62/504,833 filed May 11, 2017, the entire contents of which are hereby incorporated by reference.

### BACKGROUND

Content is king on the Internet. The more content you have, and the higher quality content you have, the more users you can attract to your website or online service, and the longer they stay.

Unfortunately, content is expensive to create, which is why crowdsourced content is so effective, usually served up on a social media platform. Users may spend hours on YouTube watching videos that YouTube had no role in creating.

Media comes in different types, such as video, audio, and images, and each type of media is created and experienced differently, and thus have different social media services. Videos work better on YouTube, group conversations work better on Facebook, and headline text works better on Twitter.

Augmented reality (AR) is a new form of media made possible by technological advances. In AR, users walk through the real world looking at what a camera on their mobile device sees. Through the camera, of course they see the real world, whatever the camera is aimed at. Then software overlays content on top of that real world view, such as a 3D model of an elf. Though the elf model is not real, it is placed into the real world environment at a given location, such as standing on a tree stump. As the user moves the mobile device, the camera's view of course changes, but sensors in the mobile device notice this motion and redraw the 3D model elf as though it is still standing on the stump.

People love to express themselves in shared public locations, such as graffiti art spray-painted onto a wall, or chalk drawings sketched on a sidewalk. Augmented reality media will similarly be popular, a way to graffiti any wall virtually, without the spray paint. Through AR, a community could mark up any shared physical space with images, video, 3D models, and even interactive 3D experiences. What is the social media platform that will collect, aggregate, and display AR content?

This method is novel in many ways compared to other social media platforms, because of factors including:
How content is viewed, because an AR environment can only be seen using AR software and a mobile device with a camera and sensors in a real-world space;
Content understands its surroundings, because interactive content can literally be aware of the users watching it and the location it is placed in.
Map knowledge, where interactive content is further aware of its geographic coordinates and nearby map metadata, and because map information can be used when placing AR content into an AR environment.
A sense of the viewer, where viewers' locations, directions of movement, and speeds of movement can be used to automatically place content, and to make it interactive.
3D objects, which are not found on typical social media platforms. They can be static, animated, or interactive, and can be observed from all sides by simply moving in the real world around the content location.
Motion, where the user must move through the real world to view new content.

### SUMMARY

Briefly, the techniques described herein assume an augmented reality environment with content that can be laid out across real world locations, with a community of users who may wish to create or experience content.

Using an interface, User X creates a topic-based content feed called a “dimension” which other users can join as editors or viewers. Editors of the dimension can then post content into the feed of the dimension. User X has administrative privileges to moderate editors and the posts that they make. Other users may “follow” User X's dimension, meaning that they register themselves as regular viewers.

Posted content appears in augmented reality and can be 3D, 2D, or textual in nature. The 3D models can be interactive, and several 3D models can be lined up into a “quest” that spans multiple locations. Content may be affiliated with topical tags or references to other dimensions. Users who post content agree to allow their content to be seen by others.

Viewers with a mobile device may then see content in the augmented reality environment by using AR software. The sequential and chronological posts of a content feed are laid out in the AR environment along a pathway that begins directly in front of the viewer and goes off into the distance.

Viewers can manipulate and refine what type of content they see using controls of their AR device, including gestures, swiping, typing, pointing, moving, and voice commands. A viewer can traverse the content either by physically walking along the pathway of content locations or by using the controls of the AR software to change dimensions (topical feeds) or to scroll distant content closer.

This content will be viewed in an AR context, so that the user can view the content from different angles by walking around it, and interact with the content in a way that is contextualized by the physical world and map metadata nearby.

The system may allow viewers to configure the content they see:
Selecting the dimension (topical feed) they wish to view;
Filtering content by topic or keyword;
Aggregating content from all the dimensions that they follow; or
Receiving content automatically aggregated by algorithms as likely to be of interest.

Sponsored or featured content may be mixed in with crowdsourced content.
Users may interact with AR content in a variety of ways:
Upvoting, downvoting, or flagging it as abusive
Pinning content to a map location
Sharing content
Replying to content

To show a dimension (content feed), the system automatically lays out the foremost items in the field of view of a user, in the direction indicated by the user's compass orientation or direction of motion, or along a pathway to a specific destination indicated by the user. As the user moves through the real world, he or she leaves the first feed posts behind, approaches the next feed posts, and the system adds even more posts on the approaching landscape horizon. If the user leaves the path of the content to move in a different direction, the content is laid down fresh in the new direction indicated by motion. The user can also scroll through content with a flick of the finger, so that each item placed in the view advances by one position.

The challenges are then:
a) What is the best way to place a feed of content into an augmented reality view?
b) What is the best way to aggregate content suggestions from multiple sources into a suggested content feed?
c) What is the best way to allow content to be ‘pinned’ to map locations?
d) What is the best way to administrate content in map locations that are privately owned, such as a school or factory?

These problems are solved with a method according to a preferred embodiment in the following way:
a) When the user has the mobile app open to show the augmented reality view, the view from the mobile device's camera is shown with overlaid content. Overlaid content is laid down in order of first post to last post in the feed at farther and farther distances from the user. This creates a path that the user may choose to travel, but should the user turn away and leave the path, the remaining content is repositioned so that it is always ahead.
b) A weighted scoring system can balance several factors in choosing posts for an aggregate feed, starting with the source dimensions:
   Content from dimensions that you follow;
   Optionally, sponsored content; or
   Content from dimensions recommended to be of interest to is you based on Bayesian analysis;
   And then picking the best posts from such dimensions:
   Posts upvoted or clicked on the most by others, especially users you are following;
   How recently the content was posted; or
   Bayesian analysis based on keywords or tags of the post.
c) Users can pin content to a location by physically walking there and using their augmented reality view and controls to precisely place an object, or by simply clicking a location on a map.
d) Individuals, organizations, and governments may claim territory that they administrate, submitting such a claim through a manual vetting process, or by demonstrating that they own an email address that matches map metadata for a given location. Owners of a real-world territory would have the ability to moderate content pinned to locations inside their territory.

### BRIEF DESCRIPTION OF THE DRAWINGS

The foregoing and other features, and advantages will be apparent from the following more particular description of preferred embodiments, as illustrated in the accompanying drawings in which like reference characters refer to the same parts throughout the different views.

FIG. 1 shows how dimensions within the augmented reality environment are set up and administrated.

FIG. 2 shows how content is shown to the User.

FIG. 3 shows how the user can change content feeds and interact with content

FIG. 4 shows how an automated content feed can be created.

FIG. 5 shows the placement of pinned content through the User's view.

FIG. 6 shows a data schema for storing, choosing, and displaying content feeds

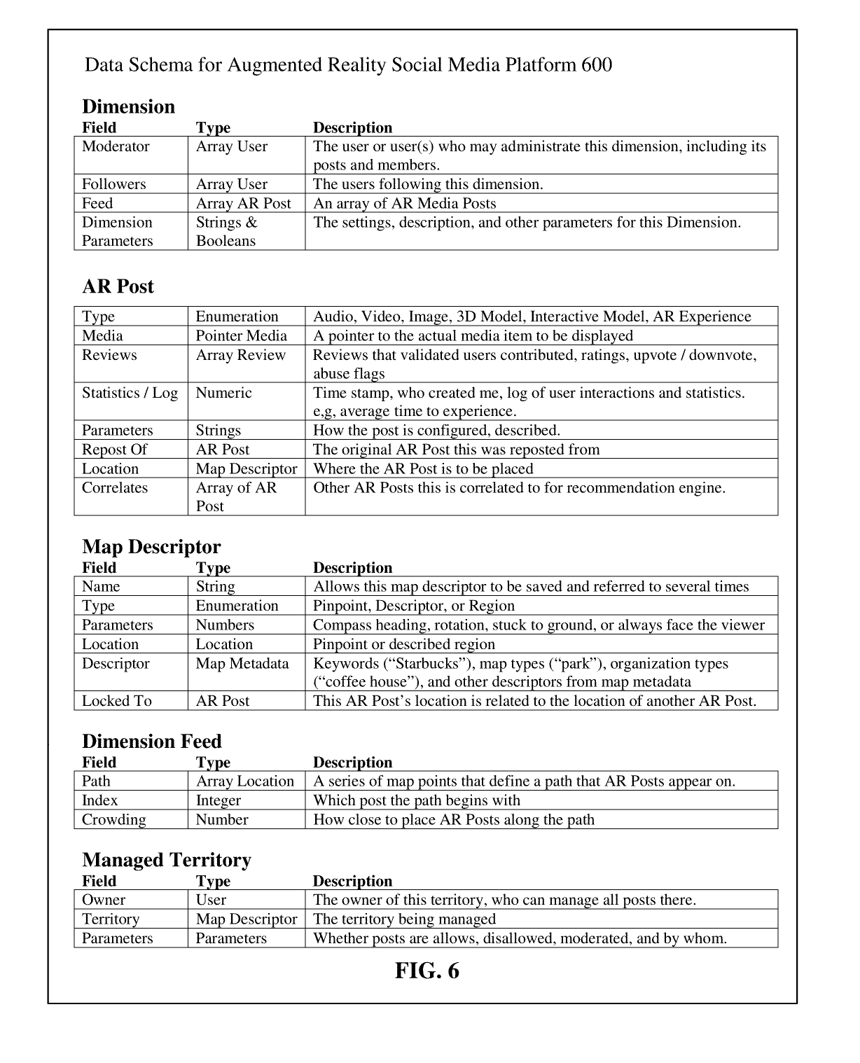

### DETAILED DESCRIPTION

A description of preferred embodiments follows.

### Dimension Setup and Posting AR Content to Its Feed

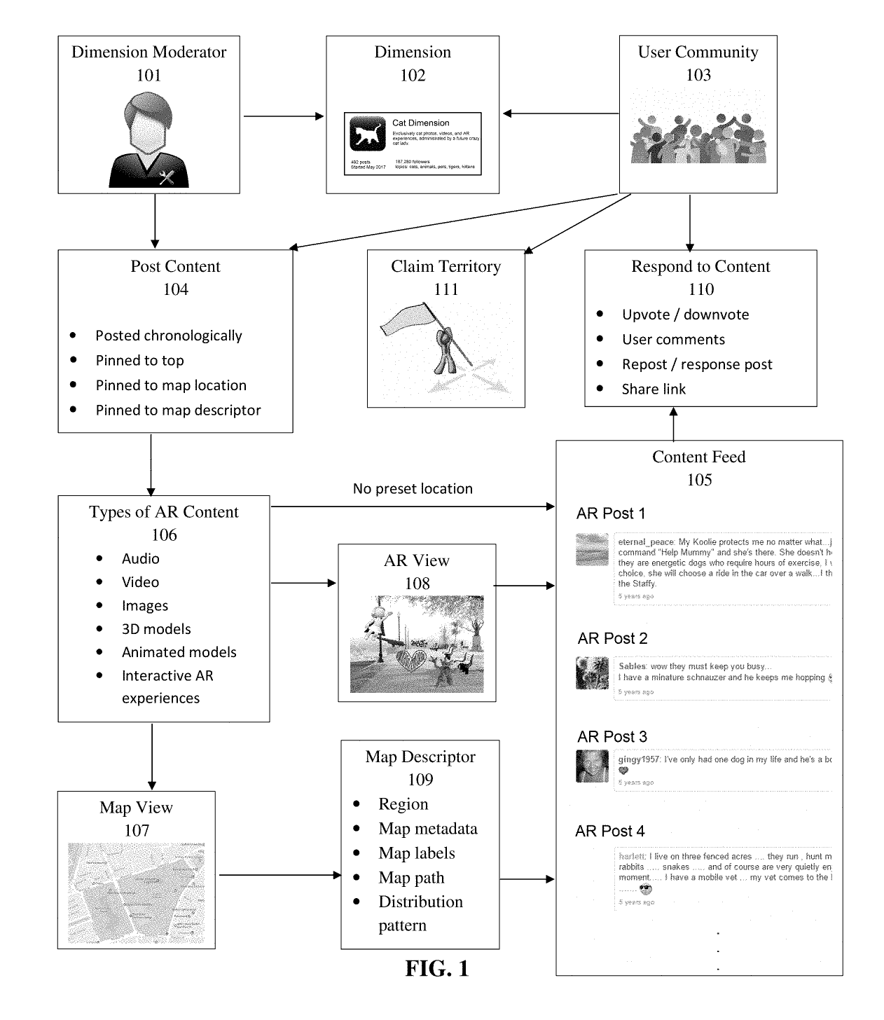

FIG. 1 shows how a dimension is set up and posts made to it.

First a moderator 101, who could be a system administrator or a member of the user community, creates the dimension 102, configuring parameters using a mobile device or personal computer. These parameters get stored on a cloud server, and could include:
A name
An icon or logo
A description
Rights about who may post content

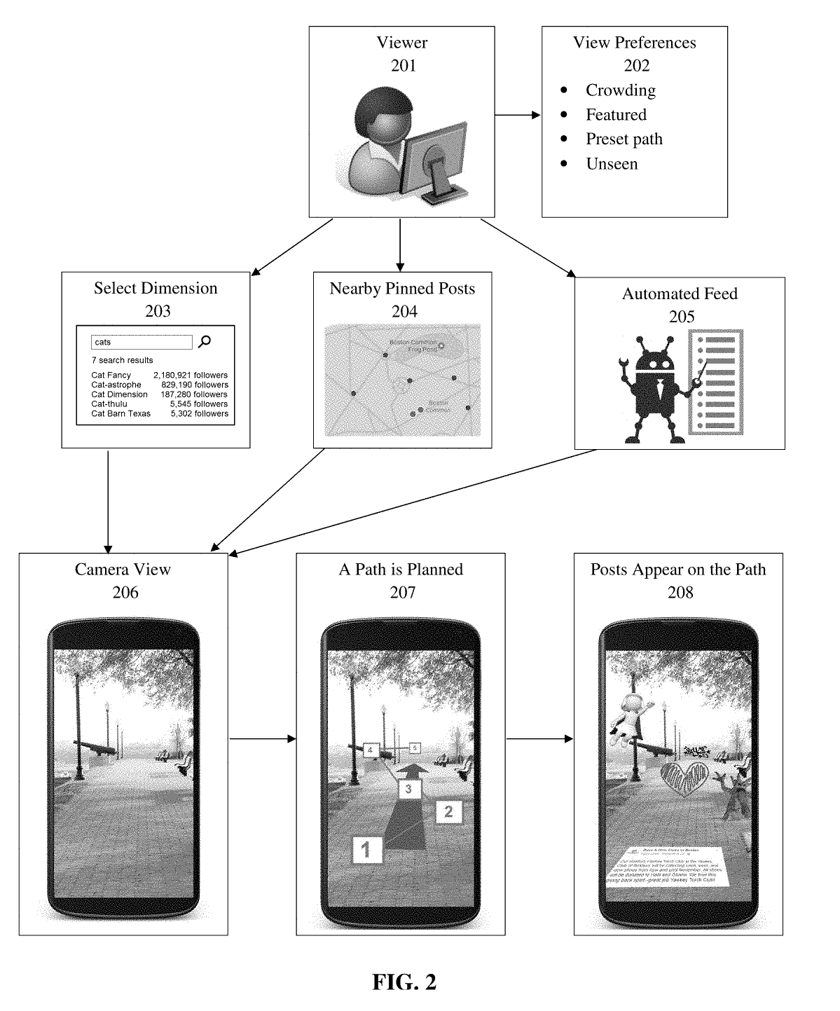

Then a User Community 103 may use a mobile device or personal computer to follow or join the dimension, giving them access to see the individual AR media posts in the Content Feed 105 as shown in FIG. 2. The User Community 103 may or may not have access to post content to Content Feed 105.

The Dimension Moderator 101 or User Community 103 then Posts Content 104 using a mobile device or personal computer that may be of a variety of Types of AR Content 106:
Audio
Video, which is placed as a 2D object into the 3D AR world
Images, which are also placed as 2D objects
3D models, which may be animated, or
Interactive AR experiences, where the 3D models engage with viewers or their environment

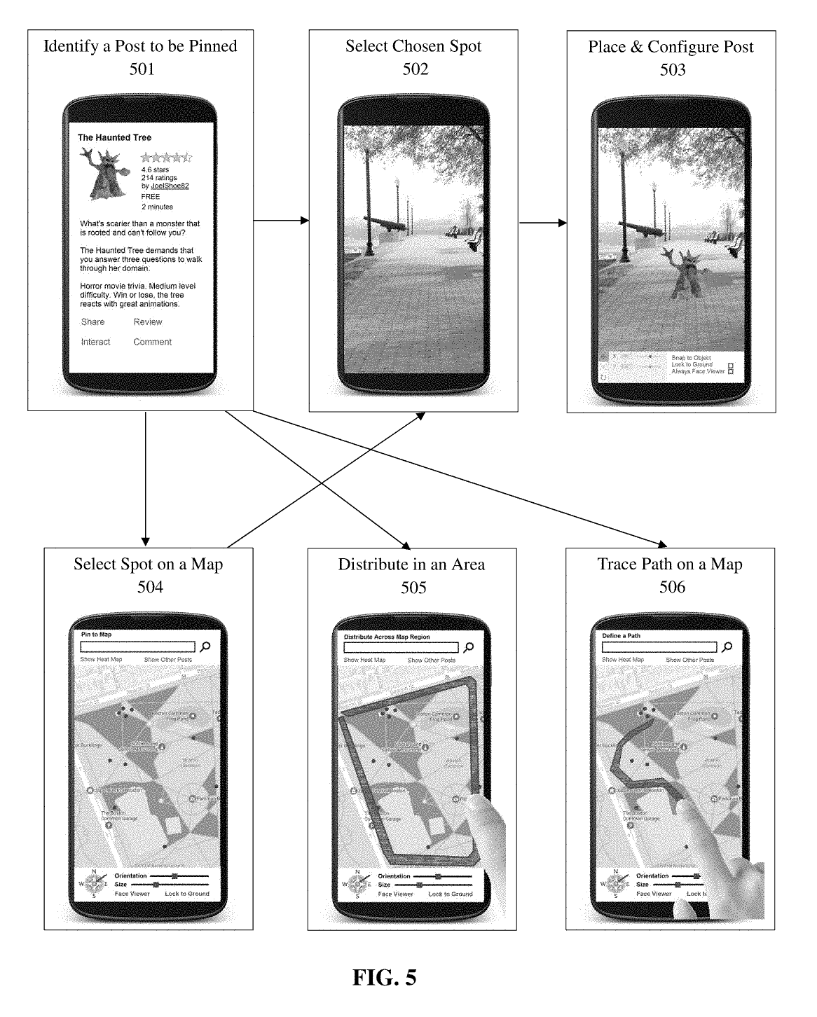

This content is either posted at no map location, e.g. to be placed automatically, or “pinned” to a map location or locations as in FIG. 5:
In person, when the viewer is physically present at the desired map location, using the AR View 108 on his or her mobile device, and possibly configuring its size, orientation, and elevation,
Directly onto a map coordinate by clicking a location on a Map View 107, or
By specifying a Map Descriptor 109, which can be defined and named separately and then referenced when placing an object. This allows the user to describe the location(s) where content is to go, for example:
   Inside a named map region, e.g. “Portland, Oregon”,
   Inside a defined map region, e.g. a polygon drawn on the map,
   At map labels, e.g. at the front door of every map location marked “Pharmacy” or “Starbucks Coffee”, or
   Along a specific map path, e.g. from 123 Main Street, Boston Mass. to 456 Dayton Way, Boston, Mass.,
   And what distribution pattern is to be used, e.g. random placement, grid, or clustering, and at what distances.

With this configuration done, the Post Content 104 is then placed into the Content Feed 105, as hosted on a cloud server.

The User Community 103 may be able to Respond to Content 110, using their mobile devices, by giving positive or negative feedback, flagging content as abusive, giving a text comment in response, responding with a full AR media post of their own, or sharing a link to the content.

The User Community 103 may also be able to use their mobile devices or a personal computer to Claim Territory 111, allowing them to moderate or forbid Post Content 104 from being placed onto an area of the Map View 107 that they own, e.g. school grounds.

### How Content May Be Displayed to Users

FIG. 2 shows how users browse content, and how content is displayed to users on a mobile device that includes a camera.

A Viewer 201 has a mobile device with a Camera View 206. The viewer may select View Preferences 202, such as:
How close together objects are to be placed in the AR view
Whether to show only featured content
Whether to place objects along a preset path instead of an automatically determined path
Whether to show content already seen in the past or to hide it

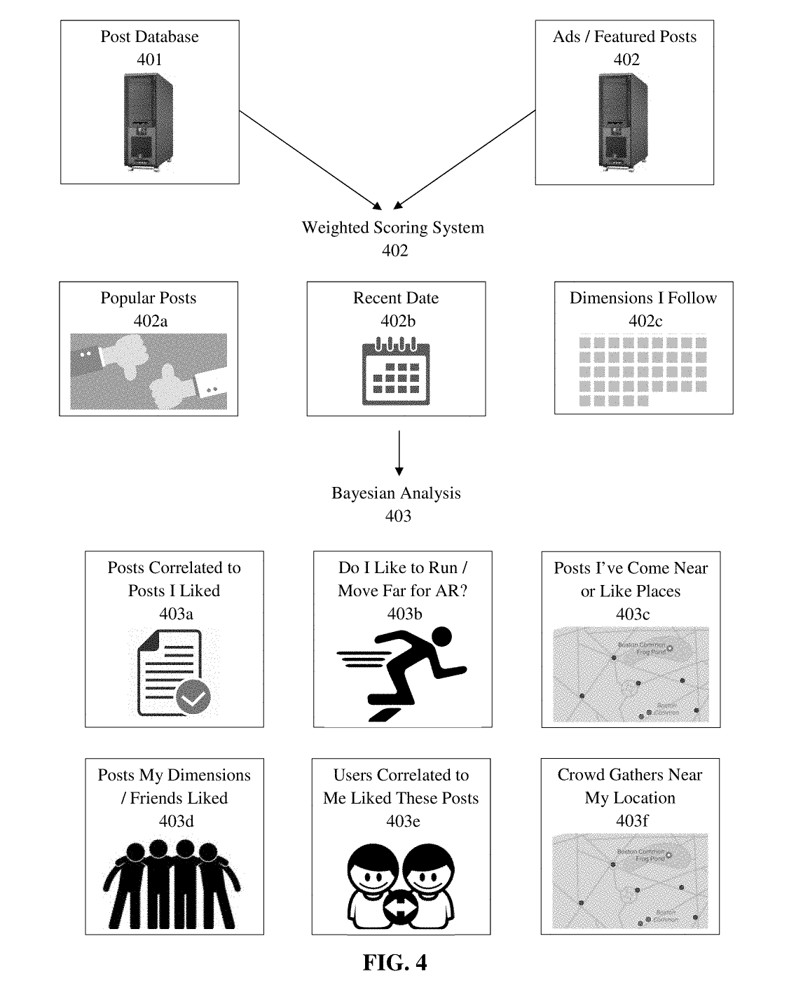

Then, using the mobile device, the viewer chooses the dimension (content feed) that he or she wishes to view, either by:
Selecting a Dimension 203 using a search interface or by browsing a list,
Finding a dimension based on its Nearby Pinned Posts 204 that are close to the viewer's GPS location or to a selected map location, or
An Automated Feed 205, which attempts to post the content most likely to be interesting, as shown in FIG. 4.

The automated system, hosted on a cloud server, then takes the Camera View 206 of the Viewer 201, and plans a path, either using the path in the View Preferences 202 or creating a Path 207 using the Viewer's 201 GPS map coordinates and compass heading. The direction of the Path 207 would be modified based on map knowledge. For example, a path could go in any direction in a public park, along a known street in a city, or would stop if the user came up abruptly to a building or lake without any map route forward.

An algorithm running on the cloud servers then takes the first few posts in the chosen feed, and places them along the Path 207, as shown to the user through his or her mobile device with a camera. The items are distributed either directly along the path, or randomly nearby it. In this example 207, the first 5 posts are shown in chronologically order, with the most recent being “1” and the last being “5”. The placement of AR content in the example zigzags left and right along the path.

Then Posts Appear on the Path 208 in the computed locations and can be seen by the Viewer 201.

The User Interacts with Content

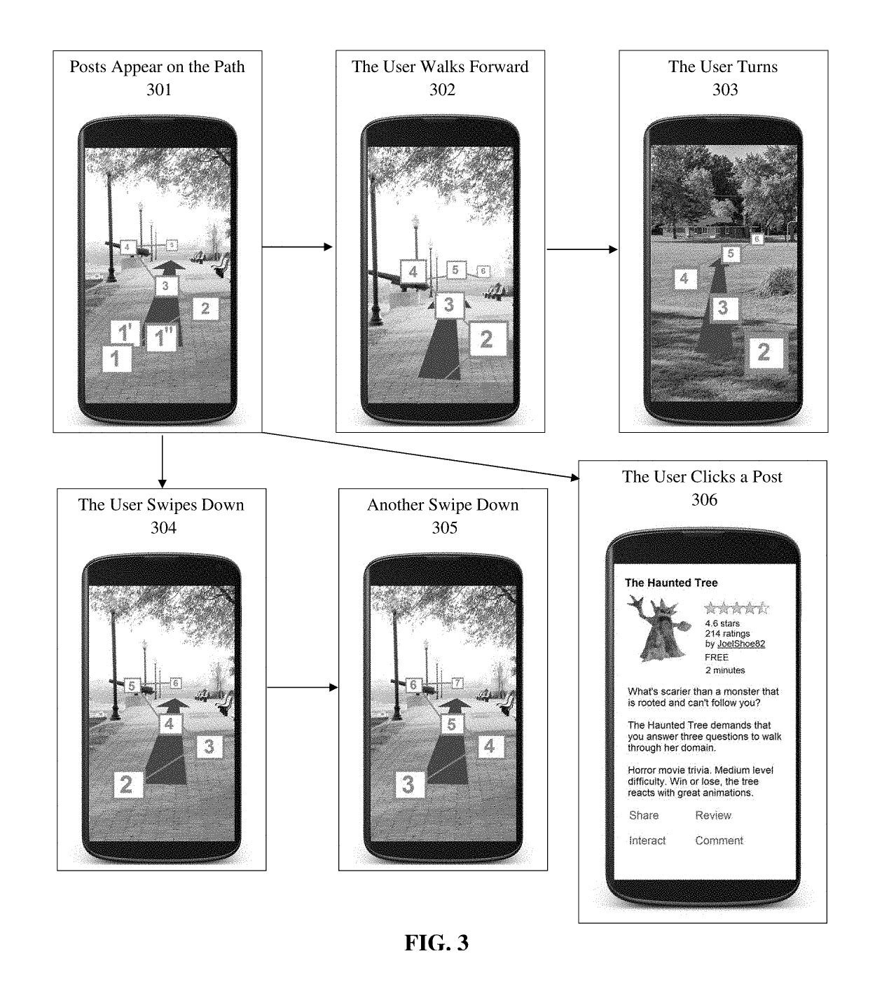

FIG. 3 shows how, once a viewer is shown content on his or her mobile device with a camera, he or she may interact with it.

First, Posts Appear on the Path 301, through the user's mobile device, being shown as an overlay to the live view through the device's mobile camera. This diagram is symbolic; what is actually shown to the user are the first 5 posts in the dimension (content feed), as in 208. In this example, two other users have responded to Post 1 with posts of their own. Response posts 1′ and 1″ are shown just behind Post 1 on the path, or the viewer may be able to choose to hide all response posts. It may be possible for those posting AR media as a response to select the relative location of their content to the original content. For example, someone whose response to an elf is to make a hat will want that hat to be on top of the elf, no matter where the elf is shown.

From 301 the User Walks Forward 302. Of course, the image on the user's mobile device camera has changed, because the user is now closer to the end of the path. Originally posts 1, 2, 3, 4, and 5 were shown, but now the user has walked past post 1. Posts 2, 3, 4, and 5 remain where they are, fixed to a real world location along the path, and now a new post 6 is shown on the horizon.

Instead of walking forward more from 302, the user may turn to the right 303, and if this is a permanent turn, held for a few seconds, then the path is laid out fresh in front of the user at this new orientation. Post 1 remains behind the user, but posts 2, 3, 4, 5, and 6 now stretch out ahead along this new path, with some side-to-side zigzag added for variety.

Returning to view 301, where Posts Appear on the Path, the user may decide that he or she does not feel like walking. Making a gesture on his or her mobile device, the viewer may scroll the content towards him or her by a gesture such as swiping a finger down. This results in 304, where the camera view has not changed because the user has not moved at all. However, now items 2, 3, 4, 5, and 6 are shown, the 2nd through 6th items in the dimensional feed. Another swipe on the mobile device brings the items forward again to 305, where items 3, 4, 5, 6, and 7 are shown.

If the User Clicks a Post 306 that is displayed on his or her mobile device, he or she may see metadata about the post, which may include:
Ratings and reviews,
Information about the creator of the post,
If the post is interactive, such as a video or 3D AR experience, whether it costs money and how long it takes to play out,
A description,
A map location that the post refers to,
An option to share the post as a link or by reposting it to a different dimension,
An option to interact with the post,
An option to rate or review the post, or to flag it for abuse, or
An option to add a comment, as text or a fresh AR media post.

User interaction with an AR Post could potentially result in a payment being requested and made, with a payment made to the original owner or poster of the content.

### Automatically Aggregating a Feed

FIG. 4 show how an algorithm running on the cloud server can automatically create a combined feed from the users many interests.

If the viewer asks the cloud server algorithms to show an aggregated feed, the system could simply ask the Post Database 401 for all posts from all dimensions that the viewer follows, sorted chronologically into a single feed, and possibly intermixed with Ads and Featured Posts 402.

Alternatively, an algorithm on the cloud server could identify and suggest the posts most likely to appeal to the viewer.

A Weighted Scoring System 402 could find the most Popular Posts 402a, the posts that have a Recent Timestamp 402b, come from Dimensions the Viewer Follows 402c, and other factors.

Posts found in this manner would be weighed against posts discovered through Bayesian Analysis 403, which correlates potentially posts that could be shown to:
Posts with text or topics that are correlated to posts that I liked in the past, 403a,
Interactive AR media that requires running, if I've enjoyed such in the past, 403b,
Interactive AR that requires a long walk to potentially multiple new locations, if I've enjoyed such “routes” in the past, 403b,
Interactive AR that tends to relocate me to regions that I have visited before in my GPS history, or are on the path I've pre-set that I'm following, 403b,
Posts correlated with my past record of GPS locations, 403c,
Posts repeated in many locations that have been especially popular in a location similar to the one that I'm in, for example an AR school bus that has been popular in front of schools may pop up into my feed when I pass a school, 403c,
Posts that others who follow the same dimensions that I do liked, 403d,
Posts that my friends liked, 403d, and
Posts liked by other users correlated to me through GPS locations, profile attributes, and real world behaviors 403e.

Finally, although posts that are pinned on a map should not show up in front of a viewer who is elsewhere, the user may be shown, through his or her mobile device, alerts or indicators about AR media posts pinned near to him or her that are drawing a crowd in real-time, or otherwise especially popular, 403f. These alerts could show up as arrows in the viewer's AR view, mixed in with feed posts, or in a high-level map view.

### How Content May Be Pinned to a Map Location

FIG. 5 shows the many ways that an AR media post may be pinned to a location.

First, the user, through his or her mobile device, identifies a Post to be Pinned 501. Then the user can Select a Chosen Spot 502 by physically walking somewhere in person. Then the user can Place & Configure the Post 503, by:
Walking around in the real world until the AR post in the view is exactly where the user wants it to be,
Using controls to rotate, resize, and orient the AR post,
Possibly selecting that the AR media post should always rotate to face the user, or
Possibly locking the bottom of the AR media post to the ground or some other flat surface.

A user could potentially also Select a Chosen Spot 502 remotely by selecting a Spot on a Map 504 and then pulling up on his or her mobile device or personal computer a real world image taken from some other anonym ized user at a previous time. Then without being physically present an object could be Placed & Configured 503 precisely.

A remote user may also simply click his or her mobile device to Select a Spot on a Map 504, with controls including:
Whether to show a “heat map” where other users tend to go,
Whether to show the location of other pinned posts,
Orienting the AR post towards a compass heading,
Resizing the AR post,
Possibly selecting that the AR media post should always rotate to face the user, or
Possibly locking the bottom of the AR media post to the ground or some other flat surface.

Finally, a user could potentially:
Select a Post to be Pinned 501 and have it appear randomly within an area 505,
Select Several Posts to be Pinned 501 and have them Distributed Randomly Across an Area 505,
Select Several Posts to be Pinned 501 and then Trace a Path on a Map 506 for the posts to be set up along in a series.

### An Improvement to Existing Technology

Existing social media platforms are incapable of handing augmented reality items and behavioral interactions, because:
They have no sense of the user's location,
They have no sense of the map environment surrounding the user,
They have no real-time sense of how the user is moving physically or gesturing the his or her mobile device, and
They are unable to display augmented reality information, especially in a way that is contextualized by map information, e.g.

not trivial applications such as putting a beard on someone's face.

Just as different forms of media have required different social media platforms, for example headlines being especially well handled by Twitter, augmented reality requires a different kind of interaction, sharing, is crowdsourcing, and display that justifies a specialized social media approach.

What is claimed is:

1. A method for handling crowdsourced augmented reality content, comprising:
allowing a user to create a feed of content suitable for augmented reality display;
such content to potentially include:
images;
videos;
text as displayed in a 2D format;
3D models, which may be static, animated, or interactive;
A set of 3D models along a path;
associating successive feed posts with successive real world map locations; and
either:
displaying feed content through an augmented reality view; or
making feed content and its locations available via an API.

2. A method as in claim 1 further comprising:
a system to allow users to pin feed content to a map location, this potentially to include:
selecting a single location;
defining a category of map location (e.g. all schools);
distributing content along a selected map path;
distributing content inside a select map region.

3. A method as in claim 2 further comprising:
a system to allow users to claim ownership of a territory, signifying their right to moderate content pinned there.

4. A method as in claim 1 further compromising:
a system allowing users to respond to posts, via either:
replying to the post with their own content;
sharing the post in their own feed; or
rating the post or flagging the post for abuse.

5. A method as in claim 1 further comprising:
allowing interactivity to be added to content;
allowing users to interact with this content.

6. A method as in claim 1 further comprising:
allowing a series of content to be configured as a quest that a user is meant to follow sequentially.

7. A method as in claim 1 further comprising:
a system that allows payments to be made when:
a player is shown an AR experience;
a player arrives at the sponsored location;
a player spends a specific amount of time at the sponsored location; or
a player spends a coupon given as a reward for gameplay.

8. A method as in claim 1 further comprising:
a system for advertisers to submit bids that determine which players are sent to which advertiser's sponsored location.

9. A method as in claim 1 further comprising:
the layout of feed content in successive locations based on the user's direction of travel or explicit map destination.

10. A method as in claim 1 further comprising:
the automatic generation of a customized content feed by aggregating content from disparate feeds, factors to potentially include:
a user's past willingness to run or walk a long distance;
signaling to a user that a crowd of users have gathered nearby;
correlating my current location with AR media that was well received in similar locations according to map metadata.
